(19) United States
(12) Patent Application Publication
(10) Pub. No.: US 2023/0177359 A1
(43) Pub. Date: Jun. 8, 2023

(54) METHOD AND APPARATUS FOR TRAINING DOCUMENT INFORMATION EXTRACTION MODEL, AND METHOD AND APPARATUS FOR EXTRACTING DOCUMENT INFORMATION

(71) Applicant: Beijing Baidu Netcom Science Technology Co., Ltd., Beijing (CN)

(72) Inventors: Sijin WU, Beijing (CN); Han LIU, Beijing (CN); Teng HU, Beijing (CN); Shikun FENG, Beijing (CN); Yongfeng CHEN, Beijing (CN)

(21) Appl. No.: 18/063,348

(22) Filed: Dec. 8, 2022

(30) Foreign Application Priority Data
May 20, 2022 (CN) 202210558415.5

(51) Int. Cl. G06N 5/022; G06F 40/174; G06F 40/205

(52) U.S. Cl. CPC G06N 5/022; G06F 40/174; G06F 40/205; G06F 40/30

(57) ABSTRACT

The present disclosure provides a method and apparatus for training a document information extraction model and method and apparatus for extracting document information, and relates to the field of artificial intelligence, and more particularly to the field of natural language processing. A specific implementation solution is: acquiring training data labeled with an answer corresponding to a preset question and a document information extraction model, the training data includes layout document training data and streaming document training data; extracting at least one feature from the training data; fusing at least one feature to obtain a fused feature; inputting the preset question, the fused feature and the training data into the document information extraction model to obtain a predicted result; and adjusting network parameters of the document information extraction model based on the predicted result and the answer.

### CROSS-REFERENCE TO RELATED APPLICATIONS

The present application claims the priority of Chinese Patent Application No. 202210558415.5, titled “METHOD AND APPARATUS FOR TRAINING DOCUMENT INFORMATION EXTRACTION MODEL, AND METHOD AND APPARATUS FOR EXTRACTING DOCUMENT INFORMATION,” filed on May 20, 2022, the entire disclosure of which is incorporated herein by reference.

### TECHNICAL FIELD

The present disclosure relates to the field of artificial intelligence, particularly the field of natural language processing, and more particularly, to a method and apparatus for training a document information extraction model and method and apparatus for extracting document information.

### BACKGROUND

In real user business scenarios, the cost of labeled text is often very expensive. Therefore, a zero-shot or few-shot learning capability of a model is very important, which determines whether the information extraction model can be widely used and deployed in a plurality of different vertical types of application scenarios.

At the same time, a small amount of labeled data given by the user may contain streaming documents (*.doc, *.docx, *.Wps, *. Txt, *.excel, etc.) and layout documents (*.pdf, *.jpg, *.Jpeg, *.Png, *.Bmp, *.Tif, etc.). In order to use the labeled data given by the user as much as possible, the model is adequately trained according to the user requirements, and therefore it is necessary to integrate the streaming document information extraction capability and the layout document information extraction capability into the model with the unified architecture.

### SUMMARY

The present disclosure provides a method and apparatus for training a document information extraction model and method and apparatus for extracting document information, device, storage medium, and computer program product.

According to a first aspect of the present disclosure, a method for training a document information extraction model is provided, the method may include: acquiring training data labeled with an answer corresponding to a preset question and a document information extraction model, the training data includes layout document training data and streaming document training data; extracting at least one feature from the training data; fusing the at least one feature to obtain a fused feature; inputting the preset question, the fused feature and the training data into the document information extraction model to obtain a predicted result; and adjusting network parameters of the document information extraction model based on the predicted result and the answer.

According to a second aspect of the present disclosure, a method for extracting document information, the method may include: acquiring document information to be extracted; extracting at least one feature from the document information; fusing the at least one feature to obtain the fused feature; inputting a preset question, the fused feature and the document information into the document information extraction model trained by the method according to any implementation of the first aspect, to obtain an answer.

According to a third aspect of the present disclosure, an apparatus for training a document information extraction model is provided, the apparatus may include: an acquisition unit, configured to acquire training data labeled with an answer corresponding to a preset question and a document information extraction model, the training data includes layout document training data and streaming document training data; an extraction unit, configured to extract at least one feature from the training data; a fusion unit, configured to fuse the at least one feature to obtain a fused feature; a prediction unit, configured to input the preset question, the fused feature and the training data into the document information extraction model to obtain a predicted result; and an adjustment unit, configured to adjust network parameters of the document information extraction model based on the predicted result and the answer.

According to a fourth aspect of the present disclosure, an apparatus for extracting document information, the apparatus may include: an acquisition unit, configured to acquire document information to be extracted; an extraction unit, configured to extract at least one feature from the document information; a fusion unit, configured to fuse the at least one feature to obtain the fused feature; a prediction unit, configured to input a preset question, the fused feature and the document information into the document information extraction model trained by the apparatus according to any implementation of the second aspect to obtain an answer.

According to a fifth aspect of the present disclosure, an electronic device including at least one processor and a memory in communication with the at least one processor is provided; the memory stores instructions executable by the at least one processor to enable the at least one processor to perform the method according to any implementation of the first aspect.

According to a sixth aspect of the present disclosure, a non-transitory computer readable storage medium storing computer instructions, where the computer instructions are used to cause the computer to perform the method according to any implementation of the first aspect.

According to a seventh aspect of the present disclosure, a computer program product is provided. The computer program product includes a computer program/instruction, the computer program/instruction, when executed by a processor, implements the method according to any implementation of the first aspect.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute a limitation to the present disclosure. In which:

FIG. 1 is an exemplary system architecture in which an embodiment of the present disclosure may be applied;

FIG. 2 is a flowchart of an embodiment of a method for training a document information extraction model according to the present disclosure;

FIGS. 3a-3b are schematic diagrams of an application scenario of a method for training the document information extraction model according to the present disclosure;

FIG. 4 is a flowchart of an embodiment of a method for extracting document information according to the present disclosure;

FIG. 5 is a schematic structural diagram of an embodiment of an apparatus for training a document information extraction model according to the present disclosure;

FIG. 6 is a schematic structural diagram of an embodiment of an apparatus for extracting document information according to the present disclosure;

FIG. 7 is a schematic structural diagram of a computer system suitable for implementing an electronic device of an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

It is noted that the embodiments in the present disclosure and the features in the embodiments may be combined with each other without conflict. The present disclosure will now be described in detail with reference to the accompanying drawings and embodiments.

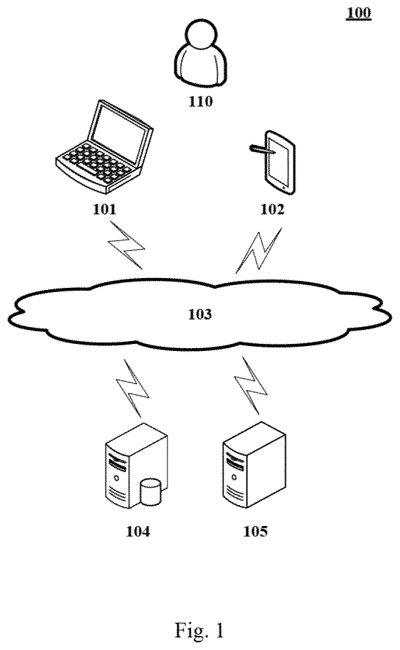

FIG. 1 illustrates an exemplary system architecture 100 in which a method for training a document information extraction model, an apparatus for training the document information extraction model, a method for extracting document information, or an apparatus for extracting document information of an embodiment of the present disclosure may be applied.

As shown in FIG. 1, the system architecture 100 may include terminals 101, 102, a network 103, a database server 104, and a server 105. The network 103 serves as a medium for providing a communication link between the terminals 101, 102, the database server 104 and the server 105. The network 103 may include various types of connections, such as wired, wireless communication links, or fiber optic cables, etc.

The user may interact with the server 105 through the network 103 using the terminal devices 101, 102 to receive or transmit information or the like. Various client applications may be installed on the terminal devices 101, 102, such as model training applications, document information extraction applications, shopping applications, payment applications, web browsers, instant messaging tools, and the like.

The terminal devices 101, 102 may be hardware or software. When the terminal devices 101, 102 are hardware, they may be various electronic devices with display screens, including but are not limited to, a smartphone, a tablet computer, an e-book reader, an MP3 player (Moving Picture Experts Group Audio Layer III, Moving Picture Experts Group Audio Layer III), a laptop portable computer, a desktop computer, and the like. When the terminal devices 101, 102 are software, they may be installed in the electronic devices listed above. It may be implemented as a plurality of software or software modules (for example, to provide distributed services), or as a single software or software module. It is not specifically limited herein.

The database server 104 may be a database server that provides various services. For example, a sample set may be stored in the database server. The sample set contains a large number of samples, i.e., training data. The samples may include layout document training data and streaming document training data. In this way, the user 110 may also select a sample from the sample set stored in the database server 104 through the terminals 101, 102.

The server 105 may provide various services. For example, a background server that provides support for various applications displayed on the terminals 101, 102. The background server may train the initial model using the samples in the sample set transmitted by the terminals 101, 102, and may transmit the training result (e.g., the generated document information extraction model) to the terminals 101, 102. In this way, the user may use the generated document information extraction model to extract document information.

Here, the database server 104 and the server 105 may also be hardware or software. When they are hardware, they can be implemented as a distributed server cluster of multiple servers or as a single server. When they are software, they may be implemented as a plurality of software or software modules (e.g., for providing distributed services) or as a single software or software module. It is not specifically limited herein. The database server 104 and the server 105 may also be servers of a distributed system, or servers incorporating chaining blocks. The database server 104 and the server 105 may also be cloud servers, or smart cloud computing servers or smart cloud hosts with artificial intelligence technology.

It should be noted that the method for training the document information extraction model or the method for extracting document information provided in the embodiment of the present disclosure is generally executed by the server 105. Accordingly, the apparatus for training the document information extraction model or the apparatus for extracting the document information are also generally provided in the server 105.

Note that in the case where the server 105 may implement the relevant functions of the database server 104, the database server 104 may not be provided in the system architecture 100.

It should be understood that the number of the terminal devices, the networks and the servers in FIG. 1 is merely illustrative. There may be any number of the terminal devices, the networks, and the servers as desired for implementation.

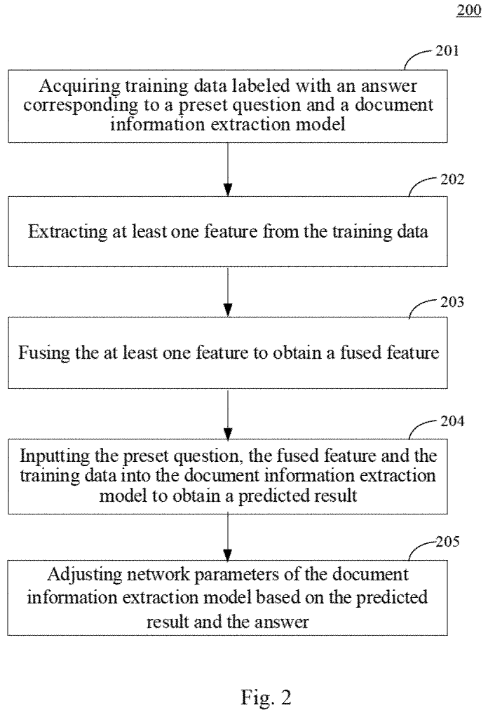

Further referring to FIG. 2, FIG. 2 illustrates a flow 200 of an embodiment of a method for training a document information extraction model in accordance with the present disclosure. The method for training the document information extraction model may include the steps of 201-205.

Step 201, acquiring training data labeled with an answer corresponding to a preset question and a document information extraction model.

In the present embodiment, an execution body of the method for training the document information extraction model (for example, the server 105 shown in FIG. 1) may acquire the training data and the document information extraction model in a plurality of ways. For example, the execution body may acquire, from a database server (for example, the database server 104 shown in FIG. 1), the existing document information extraction model and the training data stored in the database server through a wired connection mode or a wireless connection mode. For another example, a user may collect the training data including layout document training data and streaming document training data through a terminal device (e.g., the terminal devices 101, 102 shown in FIG. 1). In this way, the execution body may receive the training data collected by the terminal device and store the training data locally, thereby generating a sample set. The training data labels the answer corresponding to the preset question, for example, the question “name”, and the answer “Zhang san” is labeled. The training data may be labeled manually or by automatic labeling. The streaming document may be freely edited, and the layout may be calculated and drawn in a streaming mode when browsing. The streaming document typically contain metadata, styles, and bookmarks, hyperlinks, objects, sections (largest typesetting units, document content of different page patterns forming different sections), paragraphs, sentences, and other elements and attributes. These contents are described in a hierarchical structure, and a format of a streaming document is formed, such as word, txt, and the like. A layout document refers to a document that is not editable, that is, a document with layout, such as pdf, jpg, and the like. The layout document does not “change layout”, and the display and printing effects on any device are highly accurate and consistent. The contents, positions, styles, etc., of the words in the document are fixed at the time of generating the document. It is difficult for other people to modify and edit the document, only some information such as comments and signatures can be added to the document, and a high degree of consistency can be maintained in different software and operating systems.

The document information extraction model is a reading comprehension model including, but not limited to, ERNIE, BERT, and the like.

Step 202, extracting at least one feature from the training data.

In this embodiment, for each layout text or streaming document, at least one feature may be extracted by using existing tools. For example, semantic features, streaming reading order information, spatial position information of text characters, text segmentation information, a document type, and the like.

The streaming reading order information refers to reading text characters from left to right, and from top to bottom. In the case of the layout document, the text characters are first divided into columns from left to right and from top to bottom, and then read in each column from left to right and from top to bottom.

The spatial position information of the text characters refers to the position of the text characters in the two-dimensional space and is used to understand the overall layout of the document. For example, based on the distribution position and character size of all characters on the entire page, it is determined where the title is, where the column is, where the table is, and the like. There are six positions of the characters in the two-dimensional position embedding: x0, y0 (x and y coordinates of the point in the upper left corner of the outer frame of the characters); x1, y1 (x and y coordinates of the point in the lower right corner of the outer frame of the characters); w, h (width and height of the outer frame of the characters). We establish mapping tables for x, y, w, and h, respectively, so that the model may obtain the corresponding representation vectors of the four features x, y, w, and h of the character, respectively, through continuous learning.

The text segmentation information refers to information such as each paragraph of a document text, each cell of a table, and the like. The existing tools, such as Textmind, may be used to parse the document structure to obtain information about each paragraph of the document text, each cell of the table, and the like, and assign different segment id to different paragraphs and different cells.

The document type refers to the streaming document and the layout document. Since the model architecture proposed in the present disclosure is an open domain unified information extraction model, it is necessary to solve the information extraction tasks of the streaming document and the layout document at the same time. Therefore, a task id is added to help the model to know whether the current document is the streaming document or the layout document. The document type may be determined by the extension name of the document or some attribute information (e.g., column, title, etc.) in the document.

In conclusion, the model structure proposed in the present disclosure may ingeniously combine the input information of the four parts, so that the model may understand the text semantic information combined with the spatial position information, better learn the global features and improve the overall understanding of the document content.

Step 203, fusing the at least one feature to obtain a fused feature.

In the present embodiment, vectors of the at least one feature may be added directly to obtain the fused feature. Alternatively, the weights of the different features may be set, a sum of the weights the different features is used as the fused feature. Different features may be pre-converted into vectors of the same length.

Step 204, inputting the preset question, the fused feature and the training data into the document information extraction model to obtain a predicted result.

In the present embodiment, the answer corresponding to the preset question has been labeled in the training data. The document information extraction model can understand the semantic information of the character contained in the document. For example, if a person's date of birth (i.e., question) is to be extracted, the model must understand that the format of xxxx year xx month xx day represents date information, and then the desired content (i.e., answer) may be correctly extracted in combination with the name of the person input. This part mainly includes the text content embedding and one-dimensional position embedding, that is, a streaming reading order.

The document information extraction model is a reading comprehension model, in which questions and document information are input, and the answers, i.e., predicted results, may be found from the document information.

Step 205, adjusting network parameters of the document information extraction model based on the predicted result and the answer.

In this embodiment, a loss value is calculated based on the difference of the predicted result and the answer (cosine similarity or Euclidean distance, etc.), and the least mean square error loss function may be used. If the loss value is greater than or equal to the predetermined loss threshold, it is necessary to adjust the network parameters of the document information extraction model. The training data is then reselected, or the steps 201-205 are performed repeatedly using the original training data, to obtain the updated loss value. The steps 201-205 are performed repeatedly until the loss value is less than the predetermined loss threshold.

According to the method for training the document information extraction model in the present embodiment, an open-domain unified document information extraction model is proposed, which improves the generalization of the solution, and may at the same time ensure that the information extraction effect of the streaming document and the layout document is strong.

In some alternative implementations of the present embodiment, the acquiring the training data labeled with the answer corresponding to the preset question, includes: acquiring text content of a web page and corresponding key-value pair information by crawling and parsing the web page; and constructing a streaming document training data labeled with the answer corresponding to the preset question according to the text content and the corresponding key-value pair information. For example, the text content of the web page and the corresponding key-value pair information may be acquired by crawling and parsing an HTML web page, such as a Baidu encyclopedia or Wikipedia. Then, the massive and labeled training data for the document information extraction model on different vertical classes in different fields may be constructed by using a remote supervision scheme.

For example:

The web page text: carbon roasted pepper cake is a gourmet, main ingredients are dough, thin minced meat; assistant ingredients are coriander and fat meat; seasonings are oyster sauce, sugar, sesame oil, and the like. This gourmet is mainly produced by the method of carbon roasting.

Key-value pair: Chinese name-carbon roasted pepper cake. Taste-Salt aroma. Type-a gourmet.

“Key” in the key-value pair is a question and “value” is an answer.

In this implementation, the zero-shot and few-shot learning capabilities of the model are greatly enhanced, and mass document data is used for pre-training. Therefore, the text in different fields can be analyzed and judged without additional training data, so that the model may be reused in multiple items, and labor and material resources are saved.

In some alternative implementations of the present embodiment, the acquiring the training data labeled with the answer corresponding to the preset question, includes: acquiring the streaming document training data and a layout document set; emptying the text content in the layout document set, and retaining a document structure; filling the streaming document training data into the document structure to generate the layout document training data. The streaming document training data may be acquired by the above method, or may be acquired by other automatic labeling method or manual labeling method. By mining layout styles, chart structures, etc. of hundreds of millions of real documents, the training data of the information extraction model that is recorded in text and is labeled can be filled into layout styles, chart structures, etc., to obtain a large number of training data with abundant styles, namely, layout document training data.

In this implementation, the zero-shot and few-shot learning capabilities of the model are greatly enhanced, and the mass document data is used for pre-training. Therefore, the text in different fields can be analyzed and judged without additional training data, so that the model may be reused in multiple items, and labor and material resources are saved.

In some alternative implementations of the present embodiment, the extracting at least one feature from the training data, includes: extracting at least one of the streaming reading order information, the spatial position information of text characters, the text segmentation information, and the document type from the training data. According to the implementation mode, the text semantic information and the two-dimensional spatial position information are deeply combined, so that the model can obtain more comprehensive and more dimensional features, and the performance of the model is improved.

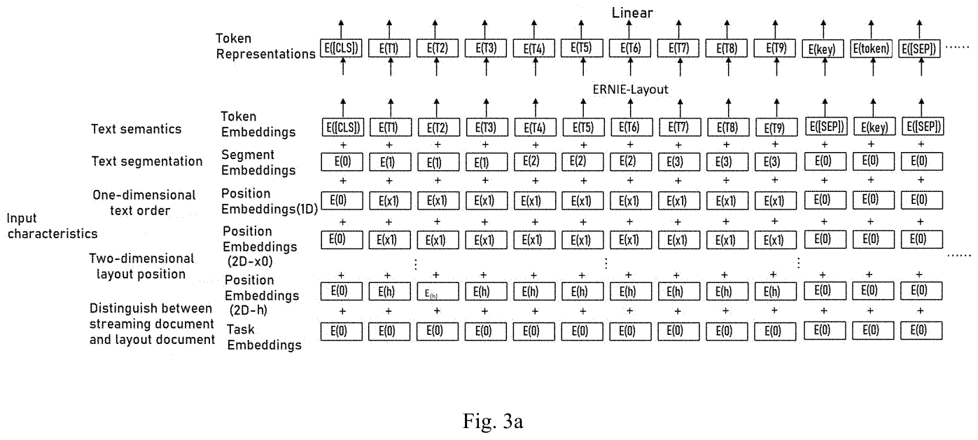

Referring further to FIGS. 3a-3b and FIGS. 3a-3b are schematic diagrams of an application scenario of a method for training the document information extraction model according to the present embodiment. In the application scenario of FIGS. 3a-3b, the input information of the task includes a plurality of features:

1. Text content and streaming reading order information. The semantic information of the character contained in the document is understood by the document pre-training language model ERNIE-layout. For example, if we want to extract the date of birth of a person, the model must understand that the format of xxxx year xx month xx day represents the date information, and then the desired content can be correctly extracted in combination with the name of the person input. This part mainly includes the text content embedding and one-dimensional position embedding.

2. Spatial position information of the text characters. The model can understand the overall layout information of the document according to the position of the text characters in the two-dimensional space. For example, based on the distribution position and character size of all characters on the entire page, it is determined where the title is, where the column is, where the table is, and the like. There are six positions of the characters in the two-dimensional position embedding: x0, y0 (x and y coordinates of the point in the upper left corner of the outer frame of the characters); x1, y1 (x and y coordinates of the point in the lower right corner of the outer frame of the characters); w, h (width and height of outer frame of the character). We establish mapping tables for x, y, w, and h, respectively, so that the model may obtain the corresponding representation vectors of the four features x, y, w, and h of the character, respectively, through continuous learning.

3. Text segmentation information. To facilitate the model understanding of the content and layout of the text, the tools, such as Textmind, may be used to parse the document structure to obtain information about each paragraph of the document text, each cell of the table, and the like, and assign different segment id to different paragraphs and different cells.

4. Distinguishing the information of streaming document and the layout document. Since the model architecture proposed in the present disclosure is an open domain unified information extraction model, it is necessary to solve the information extraction tasks of the streaming document and the layout document at the same time, so that the task id is added to help the model to know whether the current document is the streaming document or the layout document.

In conclusion, the model structure proposed in the present disclosure may ingeniously combine the input information of the four parts, so that the model may understand the text semantic information combined with the spatial position information, better learn the global features and improve the overall understanding of the document content by the model.

In order to improve the generalization of the model and the accuracy of the information extraction, the present disclosure may employ the most advanced large-scale document pre-training model ERNIE-layout (structure) as a base and infrastructure of the model, which introduces two-dimensional spatial position information so that the model can learn rich multi-modal features.

All the input characters are concatenated in sequence, and special symbols such as [CLS] and [SEP] are used for spacing text and information extraction query. Then, all the various kinds of representation information of each character are added separately, and input to the ERNIE-layout model one by one, and the features of the document contents are further fused and extracted through the multi-layer transformer structure arranged in the ERNIE-layout model. The representation of each character is then input into the linear layer, and softmax is used to obtain the final BIO result. Finally, the Viterbi algorithm is used to obtain the global optimal answer.

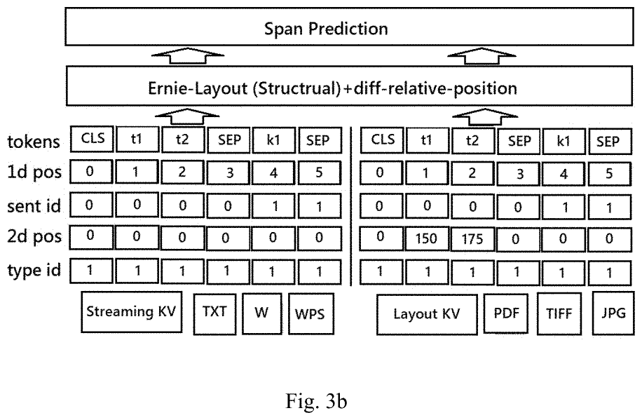

Referring to FIG. 4, FIG. 4 illustrates a flow 400 of one embodiment of a method for extracting document information provided by the present disclosure. The method for extracting document information may include the steps of 401-404.

Step 401, acquiring document information to be extracted.

In the present embodiment, the execution body of the method for extracting the document information (for example, the server 105 shown in FIG. 1) may acquire the document information to be extracted in a plurality of ways. For example, the execution body may acquire, from the database server (for example, the database server 104 shown in FIG. 1), the document information to be extracted stored in the database server through the wired connection or the wireless connection. For another example, the execution body may also receive document information to be extracted acquired by the terminal device (e.g., the terminal devices 101, 102 shown in FIG. 1) or other device. The document information to be extracted may be the streaming document or may be the layout document.

Step 402, extracting at least one feature from the document information.

In the present embodiment, the document information corresponds to the training data in the step 202, and at least one feature may be extracted from the document information by the method described in the step 202, and details are not described herein.

Step 403, fusing the at least one feature to obtain the fused feature.

In the present embodiment, the at least one feature may be fused using the method described in step 303 to obtain the fused feature, and details are not described herein.

Step 404, inputting a preset question, the fused feature, and the document information into the document information extraction model to obtain the answer.

In this embodiment, the execution body may input the document information acquired in step 401, the fused feature acquired in step 403, and the preset question into the document information extraction model, thereby generating the predicted result. The predicted result is the answer extracted from the document information.

In this embodiment, the document information extraction model may be generated by using a method as described in the embodiment of FIG. 2 described above. The specific generation process may be described in relation to the embodiment of FIG. 2, and details are not described herein.

It should be noted that the method for extracting the document information of the present embodiment may be used to test the document information extraction model generated by each of the above embodiments. The document information extraction model can be continuously optimized according to the test results. The method may also be an actual application method of the document information extraction model generated by each embodiment. The document information extraction model generated in each of the above embodiments is used to extract document information, thereby improving the performance of the document information extraction model, improving the efficiency and accuracy of document information extraction, and reducing the labor cost. Meanwhile, the time of the document information extraction may be shortened, so that the user maynot be aware of the document information extraction and may not affect the user experience.

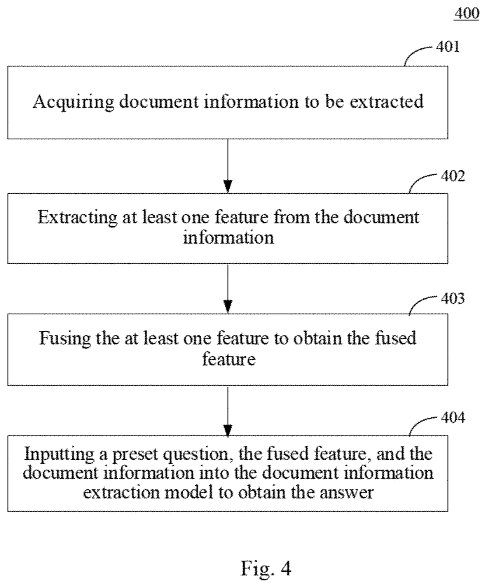

Further referring to FIG. 5, as an implementation of the method illustrated in the above figures, the present disclosure provides an embodiment of an apparatus for training a document information extraction model. The apparatus embodiment corresponds to the method embodiment shown in FIG. 2, and the apparatus is particularly applicable to various electronic devices.

As shown in FIG. 5, the apparatus 500 for training document information extraction model of the present embodiment may include an acquisition unit 501, an extraction unit 502, a fusion unit 503, a prediction unit 504, and an adjustment unit 505. The acquisition unit 501 is configured to acquire training data labeled with an answer corresponding to a preset question and a document information extraction model, the training data includes layout document training data and streaming document training data; the extraction unit 502 configured to extract at least one feature from the training data; the fusion unit 503 configured to fuse at least one feature to obtain a fused feature; the prediction unit 504 configured to input the preset question, the fused feature and the training data into the document information extraction model to obtain a predicted result; and the adjustment unit 505 configured to adjust network parameters of the document information extraction model based on the predicted result and the answer.

In some alternative implementations of the present embodiment, the acquisition unit 501 is further configured to: acquire text content of a web page and corresponding key-value pair information by crawling and parsing the web page; and; construct a streaming document training data labeled with the answer corresponding to the preset question according to the text content and the corresponding key-value pair information.

In some alternative implementations of the present embodiment, the acquisition unit 501 is further configured to: acquire the streaming document training data and a layout document set; empty text content in the layout document set and retaining a document structure; and fill the streaming document training data into the document structure to generate the layout document training data.

In some alternative implementations of the present embodiment, the extraction unit 502 is further configured to: extract at least one of the streaming reading order information, the spatial position information of text characters, the text segmentation information, and the document type from the training data.

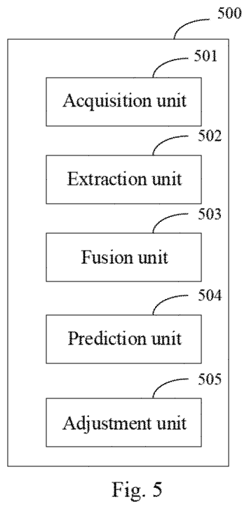

Further referring to FIG. 6, as an implementation of the method illustrated in the above figures, the present disclosure provides an embodiment of an apparatus for extracting document information. The apparatus embodiment corresponds to the method embodiment shown in FIG. 4, and the apparatus is particularly applicable to various electronic devices.

As shown in FIG. 6, the apparatus 600 for extracting document information of the present embodiment may include an acquisition unit 601, an extraction unit 602, a fusion unit 603, and a prediction unit 604. The acquisition unit 601 is configured to acquire document information to be extracted; the extraction unit 602 is configured to extract at least one feature from the document in formation; the fusion unit 603 is configured to fuse the at least one feature to obtain the fused feature; the prediction unit 604 is configured to input a preset question, the fused feature and the document information into the document information extraction model trained by the apparatus 500 to obtain an answer.

In the technical solution of the present disclosure, the processes of collecting, storing, using, processing, transmitting, providing, and disclosing the user's personal information all comply with the provisions of the relevant laws and regulations, and do not violate the public order and good customs.

According to the method and apparatus for training the document information extraction model and the method and apparatus for extracting the document information provided in the embodiments of the present disclosure, a natural language processing technology is used to meet the requirements of enterprise customers for document information extraction, thereby integrating the streaming document and the layout document information extraction capability. A brand-new feature is introduced to differentiate between the streaming document and the layout document information, so that the information extraction effect of the model is kept while the universality of the model is improved, and the privatization cost is reduced. At the same time, the two-dimensional spatial layout information of the document is introduced, so that the extraction effect of the layout document information is improved.

According to an embodiment of the present disclosure, the present disclosure also provides an electronic device, a readable storage medium, and a computer program product.

An electronic device including at least one processor; and a memory communicatively connected to the at least one processor; where, the memory stores instructions executable by the at least one processor, and the instructions, when executed by the at least one processor, cause the at least one processor to perform the method described in flow 200 or 400.

A non-transitory computer readable storage medium storing computer instructions, wherein, the computer instructions are used to cause the computer to perform the methoddescribed in flow 200 or 400.

A computer program product, including a computer program/instruction, the computer program/instruction, when executed by a processor, implements the method described in flow 200 or 400.

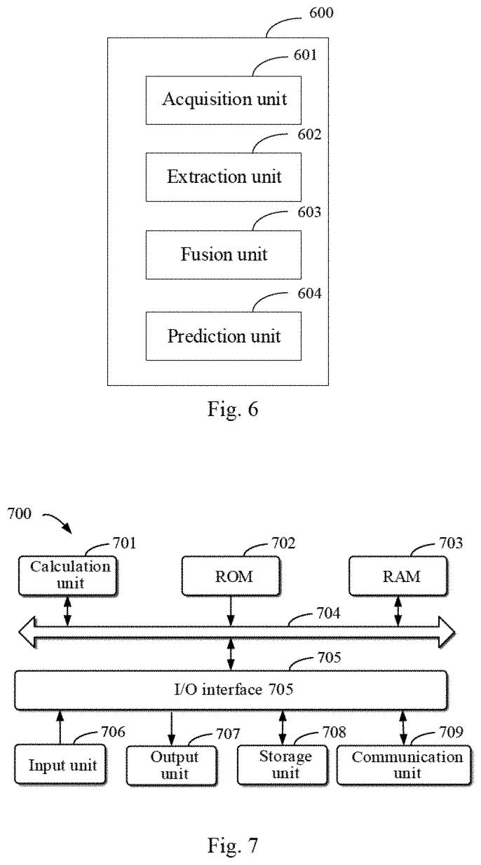

FIG. 7 illustrates a schematic block diagram of an example electronic device 700 that may be used to implement embodiments of the present disclosure. The electronic device is intended to represent various forms of digital computers, such as laptop computers, desktop computers, worktables, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 7, The electronic device 700 includes a calculation unit 701, which may perform various appropriate actions and processes according to a computer program stored in a read-only memory (ROM) 702 or a computer program loaded into a random access memory (RAM) 703 from a storage unit 708. In RAM 703, various programs and data required for operation of the device 700 may also be stored. The calculation unit 701, ROM 702 and RAM 703 are connected to each other via a bus 704. An input/output (I/O) interface 705 is also connected to a bus 704.

A plurality of components in the device 700 are connected to the I/O interface 705, including: an input unit 706, such as a keyboard, a mouse, and the like; an output unit 707, such as, various types of displays, speakers, and the like; the storage unit 708, such as a magnetic disk, an optical disk, or the like; and a communication unit 709, such as a network card, a modem, or a wireless communication transceiver. The communication unit 709 allows the device 700 to exchange information/data with other devices over a computer network such as the Internet and/or various telecommunications networks.

The calculation unit 701 may be various general-purpose and/or special-purpose processing components having processing and computing capabilities. Some examples of calculation units 701 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, and the like. The calculation unit 701 performs various methods and processes described above, such as a method for extracting document information. For example, in some embodiments, the method for extracting document information may be implemented as a computer software program tangibly embodied in a machine-readable medium, such as the storage unit 708. In some embodiments, some or all of the computer program may be loaded and/or installed on the device 700 via the ROM 702 and/or the communication unit 709. When the computer program is loaded into the RAM 703 and executed by the calculation unit 701, one or more steps of the method for extracting the document information described above may be performed. Alternatively, in other embodiments, the calculation unit 701 may be configured to perform the method for extracting the document information by any other suitable means (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output device.

Program codes for implementing the method of the present disclosure may be compiled using any combination of one or more programming languages. The program codes may be provided to a processor or controller of a general-purpose computer, a special-purpose computer, or other programmable apparatuses for processing vehicle-road collaboration information, such that the program codes, when executed by the processor or controller, cause the functions/operations specified in the flow charts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a cloud server, a distributed system server, or a server combined with a blockchain.

It should be understood that the various forms of processes shown above may be used to reorder, add, or delete steps. For example, the steps disclosed in the present disclosure may be executed in parallel, sequentially, or in different orders, as long as the desired results of the technical solutions disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for training a document information extraction model, comprising:
acquiring training data labeled with an answer corresponding to a preset question and a document information extraction model, wherein the training data comprises layout document training data and streaming document training data;
extracting at least one feature from the training data;
fusing the at least one feature to obtain a fused feature;
inputting the preset question, the fused feature, and the training data into the document information extraction model to obtain a predicted result; and
adjusting network parameters of the document information extraction model based on the predicted result and the answer.

2. The method of claim 1, wherein acquiring training data labeled with an answer corresponding to a preset question, comprises:
acquiring text content of a web page and corresponding key-value pair information by crawling and parsing the web page; and
constructing a streaming document training data labeled with the answer corresponding to the preset question according to the text content and the corresponding key-value pair information.

3. The method of claim 1, wherein acquiring training data labeled with an answer corresponding to a preset question, comprises:
acquiring the streaming document training data and a layout document set;
emptying text content in the layout document set, and retaining a document structure; and
filling the streaming document training data into the document structure to generate the layout document training data.

4. The method of claim 1, wherein extracting at least one feature from the training data, comprises:
extracting at least one of streaming reading order information, spatial position information of text characters, text segmentation information or a document type from the training data.

5. A method for extracting document information, comprising:
acquiring document information to be extracted;
extracting at least one feature from the document information;
fusing the at least one feature to obtain a fused feature;
inputting a preset question, the fused feature, and the document information into a document information extraction model trained by a method for training the document information extraction model to obtain an answer, the method for training a document information extraction model comprising:
acquiring training data labeled with an answer corresponding to the preset question and the document information extraction model, wherein the training data comprises layout document training data and streaming document training data;
extracting at least one feature from the training data;
fusing the at least one feature to obtain a fused feature;
inputting the preset question, the fused feature, and the training data into the document information extraction model to obtain a predicted result; and
adjusting network parameters of the document information extraction model based on the predicted result and the answer.

6. An electronic device, comprising:
at least one processor; and
a memory communicatively connected to the at least one processor; wherein, the memory stores instructions executable by the at least one processor to cause the at least one processor to perform operations for training a document information extraction model, the operations comprising:
acquiring training data labeled with an answer corresponding to a preset question and a document information extraction model, wherein the training data comprises layout document training data and streaming document training data;
extracting at least one feature from the training data;
fusing the at least one feature to obtain a fused feature;
inputting the preset question, the fused feature, and the training data into the document information extraction model to obtain a predicted result; and
adjusting network parameters of the document information extraction model based on the predicted result and the answer.

7. The electronic device of claim 6, wherein acquiring training data labeled with an answer corresponding to a preset question, comprises:
acquiring text content of a web page and corresponding key-value pair information by crawling and parsing the web page; and
constructing a streaming document training data labeled with the answer corresponding to the preset question according to the text content and the corresponding key-value pair information.

8. The electronic device of claim 6, wherein acquiring training data labeled with an answer corresponding to a preset question, comprises:
acquiring the streaming document training data and a layout document set;
emptying text content in the layout document set, and retaining a document structure; and
filling the streaming document training data into the document structure to generate the layout document training data.

9. The electronic device of claim 6, wherein extracting at least one feature from the training data, comprises:
extracting at least one of streaming reading order information, spatial position information of text characters, text segmentation information or a document type from the training data.
